(19) United States
(12) Patent Application Publication
(10) Pub. No.: US 2023/0038669 A1
(43) Pub. Date: Feb. 9, 2023

(54) ALLOY

(71) Applicants: Murata Manufacturing Co., Ltd., Kyoto-fu (JP); ALPS ALPINE CO., LTD., Tokyo (JP)

(72) Inventor: Tatsuya TOMITA, Sendai-shi, Miyagi (JP)

(73) Assignees: Murata Manufacturing Co., Ltd., Kyoto-fu (JP); ALPS ALPINE CO., LTD., Tokyo (JP)

(21) Appl. No.: 17/789,061

(22) PCT Filed: Dec. 22, 2020
(86) PCT No.: PCT/JP2020/048020

§ 371 Date: Jun. 24, 2022

(30) Foreign Application Priority Data
Dec. 25, 2019 (JP) 2019-234391

(51) Int. Cl. C22C 45/02; C22C 38/02; C22C 38/00; C22C 38/16; C21D 6/00

(52) U.S. Cl. CPC C22C 45/02; C22C 38/02; C22C 38/002; C22C 38/16; C21D 6/008; C21D 2201/03

(57) ABSTRACT

An alloy including an amorphous phase, and the alloy includes: an average Fe concentration in an entire alloy of 82.0 at. % or more and 88.0 at. % or less; an average Cu concentration in the entire alloy of 0.4 at. % or more and 1.0 at. % or less; an average P concentration in the entire alloy of 5.0 at. % or more and 9.0 at. % or less; an average B concentration in the entire alloy of 6.0 at. % or more and 10.0 at. % or less; an average Si concentration in the entire alloy of 0.4 at. % or more and 1.9 at. % or less; an average C concentration in the entire alloy of 0 at. % or more and 2.0 at. % or less; an average impurity concentration of an impurity other than Fe, Cu, P, B, Si, and C in the entire alloy of 0 at. % or more and 0.3 at. % or less; and a total of the average Fe concentration, the average Cu concentration, the average P concentration, the average B concentration, the average Si concentration, the average C concentration, and the average impurity concentration of 100.0 at. %.

### BACKGROUND

### 1. Technical Field

The present invention relates to an alloy, for example, an alloy containing Fe.

### 2. Description of the Related Art

A nanocrystalline alloy includes a plurality of nanosized crystal phases formed in an amorphous phase, and a Fe—Cu—P—B—Si alloy having a high saturation magnetic flux density and a low coercive force is known as such a nanocrystalline alloy, for example, as shown in WO 2010/021130 A, WO 2017/006868 A, WO 2011/122589 A, JP 2011-256453 A, and JP 2013-185162 A). Such a nanocrystalline alloy is used as a soft magnetic material having a high saturation magnetic flux density and a low coercive force.

### SUMMARY

The crystal phase is mainly an iron alloy having a body-centered cubic (BCC) structure, and when the grain size of the crystal phase is small, soft magnetic properties such as coercive force are improved. However, it is required to further improve the soft magnetic properties of the nanocrystalline alloy. Even if the soft magnetic properties are improved, production costs increase if it is difficult to produce.

The present disclosure has been made in view of the above problems, and an object of the present invention is to provide an alloy with which an amorphous alloy and a nanocrystalline alloy are easily produced.

An alloy according to the present invention, the alloy including an amorphous phase, and the alloy has:

an average Fe concentration in an entire alloy of 82.0 at. % (atom %) or more and 88.0 at. % or less;

an average Cu concentration in the entire alloy of 0.4 at. % or more and 1.0 at. % or less;

an average P concentration in the entire alloy of 5.0 at. % or more and 9.0 at. % or less;

an average B concentration in the entire alloy of 6.0 at. % or more and 10.0 at. % or less;

an average Si concentration in the entire alloy of 0.4 at. % or more and 1.9 at. % or less;

an average C concentration in the entire alloy of 0 at. % or more and 2.0 at. % or less;

an average impurity concentration of an impurity other than Fe, Cu, P, B, Si, and C in the entire alloy of 0 at. % or more and 0.3 at. % or less; and

a total of the average Fe concentration, the average Cu concentration, the average P concentration, the average B concentration, the average Si concentration, the average C concentration, and the average impurity concentration of 100.0 at. %.

The alloy according to the above aspect, wherein the average Fe concentration may be 83.0 at. % or more and 88.0 at. % or less,

the average Cu concentration is 0.4 at. % or more and 0.9 at. % or less,

the average P concentration is 5.0 at. % or more and 8.0 at. % or less,

the average Si concentration is 0.9 at. % or more and 1.4 at. % or less,

the average C concentration is 0 at. % or more and 0.1 at. % or less, and

the average impurity concentration is 0 at. % or more and 0.1 at. % or less.

An alloy according to the present invention, the alloy including an amorphous phase, and the alloy has:

an average Fe concentration in an entire alloy of 82.0 at. % or more and 88.0 at. % or less;

an average Cu concentration in the entire alloy of 0.4 at. % or more and 0.9 at. % or less;

an average P concentration in the entire alloy of 3.0 at. % or more and 9.0 at. % or less;

an average B concentration in the entire alloy of 9.0 at. % or more and 12.0 at. % or less;

an average Si concentration in the entire alloy of 1.1 at. % or more and 4.0 at. % or less;

an average C concentration in the entire alloy of 0 at. % or more and 2.0 at. % or less;

an average impurity concentration of an impurity other than Fe, Cu, P, B, Si, and C in the entire alloy of 0 at. % or more and 0.3 at. % or less; and

a total of the average Fe concentration, the average Cu concentration, the average P concentration, the average B concentration, the average Si concentration, the average C concentration, and the average impurity concentration of 100.0 at. %.

The alloy according to the above aspect, wherein the average Fe concentration may be 83.0 at. % or more and 88.0 at. % or less,

the average Cu concentration is 0.4 at. % or more and 0.8 at. % or less,

the average P concentration is 3.0 at. % or more and 5.0 at. % or less,

the average Si concentration is 1.5 at. % or more and 4.0 at. % or less,

the average C concentration is 0 at. % or more and 0.1 at. % or less, and

the average impurity concentration is 0 at. % or more and 0.1 at. % or less.

The alloy according to the above aspect, the alloy may include the amorphous phase and a plurality of crystal phases formed in the amorphous phase.

The alloy according to the above aspect, the alloy may be composed only of the amorphous phase.

According to the present invention, it is possible to provide an alloy with which an amorphous alloy and a nanocrystalline alloy are easily produced.

### BRIEF DESCRIPTION OF THE DRAWINGS

FIG. 1 is a schematic graph showing changes in temperature with respect to time in a heat treatment for forming a nanocrystalline alloy.

FIG. 2 is a schematic cross-sectional view of the nanocrystalline alloy.

### DETAILED DESCRIPTION

A method for producing an amorphous alloy and a nanocrystalline alloy will be described. First, an amorphous alloy (precursor alloy) is formed by rapidly cooling a liquid metal obtained by melting a mixture of materials. The amorphous alloy is almost in an amorphous phase and contains almost no crystal phase. That is, the amorphous alloy is composed only of the amorphous phase. Depending on the conditions of rapid cooling of the liquid metal, the amorphous alloy may contain a trace amount of crystal phase. A temperature (liquidus temperature) at which a liquid phase starts to be formed from a molten metal is defined as TL. Next, the amorphous alloy is heat-treated.

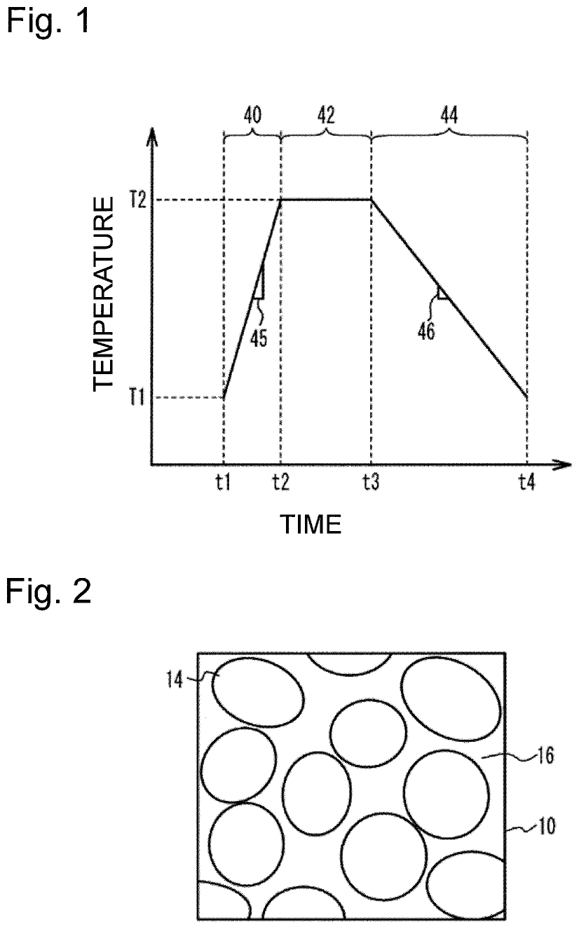

FIG. 1 is a schematic graph (schematic graph showing a temperature history of the heat treatment) showing changes in temperature with respect to time in the heat treatment for forming a nanocrystalline alloy. As shown in FIG. 1, at a time t1, the material is an amorphous alloy, and the temperature T1 is, for example, 200° C. In a heating period 40 from the time t1 to a time t2, for example, the temperature of the alloy rises from T1 to T2 at an average heating rate 45. The temperature T2 is higher than a temperature (a temperature slightly lower than a first crystallization start temperature Tx1) at which the crystal phase (metal iron crystal phase) that is iron having the BCC structure starts to be generated and lower than a temperature (a temperature slightly lower than a second crystallization start temperature Tx2) at which the crystal phase (compound crystal phase) of a compound starts to be generated. During a retention period 42 from the time t2 to a time t3, the alloy is at a substantially constant temperature T2. In a cooling period 44 from the time t3 to a time t4, for example, the temperature of the alloy decreases from T2 to T1 at an average cooling rate 46. In FIG. 1, the heating rate 45 and the cooling rate 46 are constant, but the heating rate 45 and the cooling rate 46 may change with time.

FIG. 2 is a schematic cross-sectional view of the nanocrystalline alloy. As shown in FIG. 2, an alloy 10 includes an amorphous phase 16 and a plurality of crystal phases 14 formed in the amorphous phase 16. Each crystal phase 14 is surrounded by the amorphous phase 16. The crystal phase 14 is mainly an iron alloy having the BCC structure. The alloy 10 includes Fe, Cu, P, B, and Si. C may be included intentionally or unintentionally. Impurity elements other than Fe, Cu, P, B, Si, and C may be unintentionally contained. The impurity is, for example, at least one element of Ti, Al, Zr, Hf, Nb, Ta, Mo, W, Cr, V, Co, Ni, Mn, Ag, Zn, Sn, Pb, As, Sb, Bi, S, N, O, and rare earth elements.

The average Fe concentration, Cu concentration, P concentration, B concentration, Si concentration, C concentration, and impurity concentration in the entire alloy are defined as CFe, CCu, CP, CB, CSi, CC, and CI. The sum of CFe, CCu, CP, CB, CSi, CC, and CI is 100.0 at. %. CFe, CCu, CP, CB, CSi, CC, and CI correspond to the chemical compositions of the amorphous and nanocrystalline alloys.

The size (grain size) of the crystal phase in the nanocrystalline alloy affects soft magnetic properties such as the coercive force. When the size of the crystal phase is small, the coercive force decreases, and the soft magnetic characteristics are improved. Therefore, the average value of the equivalent spherical diameters of the crystal phases 14 is, for example, preferably 50 nm or less, more preferably 30 nm or less, still more preferably 20 nm or less. The average value of the equivalent spherical diameters of the crystal phases 14 is, for example, 5 nm or more. Cu serves as a nucleation site for formation of the crystal phase 14. Therefore, the nanocrystalline alloy contains Cu. P contributes to reduction in size of the crystal phase 14. B and Si contribute to the formation of the amorphous phase 16. In order to reduce the size of the crystal phase 14, the amount of P is preferably large.

By controlling the relationship between CB, CSi, and CP, the size of the crystal phase 14 can be reduced, the coercive force can be lowered, and the soft magnetic properties are improved. In the case where the production is difficult even when the soft magnetic properties are improved, there is the problem that production costs increase and the like. When the second crystallization start temperature Tx2 is low, it is required to control the temperature T2 in the retention period after heating, and a compound crystal phase may be unintentionally generated, which makes production difficult. When Tx1/TL is small, crystal phases are formed at a lower temperature in a shorter time when the liquid metal is rapidly cooled, and the temperature at which a sound amorphous phase is formed is lowered. As a result, in order to stably obtain a sound amorphous alloy, it is necessary to further increase the rapid cooling rate of the liquid metal, and stable production becomes difficult. As described above, in order to facilitate the production, it is preferable to increase Tx2 and increase Tx1/TL.

However, in the relationship among the coercive force, Tx2, and Tx1/TL, a more preferable range of each element concentration has not been studied so far. In the following embodiments, by making the ranges of CSi and CP appropriate, the coercive force can be lowered and Tx2 and Tx1/TL can be made appropriate.

### First Embodiment

In a first embodiment, the range of each element concentration is limited mainly in the relationship among the coercive force, Tx2, and Tx1/TL. CFe is 82.0 at. % or more and 88.0 at. % or less, CCu is 0.4 at. % or more and 1.0 at. % or less, CP is 5.0 at. % or more and 9.0 at. % or less, CB is 6.0 at. % or more and 10.0 at. % or less, CSi is 0.4 at. % or more and 1.9 at. % or less, CC is 0 at. % or more and 2.0 at. % or less, and CI (total amount of impurities) is 0 at. % or more and 0.3 at. % or less.

By setting CFe to 82.0 at. % or more, the saturation magnetic flux density can be increased. CFe is more preferably 83.0 at. % or more. By increasing the concentrations of the metalloids (B, P, C, and Si), the amorphous phase 16 can be more stably provided between the crystal phases 14. Therefore, CFe is preferably 88.0 at. % or less, more preferably 86.0 at. % or less, still more preferably 85.0 at. % or less.

In the initial stage of formation of the crystal phase 14, a Cu cluster becomes a nucleation site, and the crystal phase 14 is formed. Therefore, CCu is preferably 0.4 at. % or more, more preferably 0.5 at. % or more, still more preferably 0.6 at. % or more. The presence of Cu clusters in the crystal phases 14 and the amorphous phase 16 hinders the movement of the domain wall. In addition, when Cu forms a solid solution in the crystal phases 14 and the amorphous phase 16, the quantum mechanical action between the Fe atom and the Cu atom increases. As a result, the saturation magnetic flux density decreases. From these viewpoints, CCu is preferably 1.0 at. % or less, more preferably 0.9 at. % or less, still more preferably 0.8 at. % or less.

When CP is high, the crystal phases 14 become small, and the coercive force decreases. Therefore, CP is preferably 5.0 at. % or more, more preferably 5.5 at. % or more, still more preferably 6.0 at. % or more. In order to increase CP and to set CFe to 83.0 at. % or more, CB and CSi are lowered. If CB and CSi are too low, it becomes difficult to stably form the amorphous phase 16. Therefore, CP is preferably 9.0 at. % or less, more preferably 8.5 at. % or less, still more preferably 8.0 at. % or less.

When CB is high, the amorphous phase 16 can be stably formed. In addition, as will be understood from examples described later, if CSi is increased when CB is low, Tx1/TL becomes small, and production becomes difficult. Therefore, CB is preferably 6.0 at. % or more, more preferably 6.5 at. % or more, still more preferably 7.0 at. % or more. In order to increase CB and to set CFe to 83.0 at. % or more, CP is lowered. If CP is too low, the coercive force will be high. Therefore, CB is preferably 10.0 at. % or less, more preferably 9.5 at. % or less, still more preferably 9.0 at. % or less.

When CP/CB increases, the size of the crystal phases 14 decreases, and the coercive force decreases. However, when CP increases, Tx2 decreases, and stable production becomes difficult. Higher CSi results in higher Tx2. Therefore, CSi is preferably 0.4 at. % or more, more preferably 0.6 at. % or more, still more preferably 0.9 at. % or more. In order to increase CSi and to set CFe to 83.0 at. % or more, CP is lowered. If CP is too low, the coercive force will be high. Therefore, CSi is preferably 1.9 at. % or less, more preferably 1.6 at. % or less, still more preferably 1.4 at. % or less.

From the above viewpoints, in order to optimize the balance among Tx1/TL, Tx2, and a coercive force Hc, for example, CB-CSi is most preferably 6.5 at. % or more and 9.5 at. % or less.

It is preferable that C and impurities are not intentionally added. Therefore, CC is preferably 0 at. % or more and 2.0 at. % or less, more preferably 1.0 at. % or less, still more preferably 0.1 at. % or less. CI is preferably 0 at. % or more and 0.3 at. % or less, more preferably 0.2 at. % or less, still more preferably 0.1 at. % or less. Each of the impurity elements is also preferably 0 at. % or more and 0.10 at. % or less, more preferably 0 at. % or more and 0.02 at. % or less.

### Second Embodiment

In a second embodiment, the range of each element concentration is limited mainly in the relationship among the coercive force, Tx2, and Tx1/TL. CFe is 82.0 at. % or more and 88.0 at. % or less, CCu is 0.4 at. % or more and 0.9 at. % or less, CP is 3.0 at. % or more and 9.0 at. % or less, CB is 9.0 at. % or more and 12.0 at. % or less, CSi is 1.1 at. % or more and 4.0 at. % or less, CC is 0 at. % or more and 2.0 at. % or less, and CI (total amount of impurities) is 0 at. % or more and 0.3 at. % or less.

By setting CFe to 82.0 at. % or more, the saturation magnetic flux density can be increased. CFe is more preferably 83.0 at. % or more. By increasing the concentrations of the metalloids (B, P, C, and Si), the amorphous phase 16 can be more stably provided between the crystal phases 14. Therefore, CFe is preferably 88.0 at. % or less, more preferably 86.0 at. % or less, still more preferably 85.0 at. % or less.

In the initial stage of formation of the crystal phase 14, a Cu cluster becomes a nucleation site, and the crystal phase 14 is formed. Therefore, CCu is preferably 0.4 at. % or more, more preferably 0.5 at. % or more, still more preferably 0.6 at. % or more. The presence of Cu clusters in the crystal phases 14 and the amorphous phase 16 hinders the movement of the domain wall. In addition, when Cu forms a solid solution in the crystal phases 14 and the amorphous phase 16, the quantum mechanical action between the Fe atom and the Cu atom increases. As a result, the saturation magnetic flux density decreases. From these viewpoints, CCu is preferably 0.9 at. % or less, more preferably 0.8 at. % or less.

When CP is high, the size of the crystal phases 14 becomes small, and the coercive force decreases. Therefore, CP is preferably 3.0 at. % or more, more preferably 3.8 at. % or more, still more preferably 4.0 at. % or more. In order to increase CP and to set CFe to 83.0 at. % or more, CB and CSi are lowered. If CB and CSi are too low, it becomes difficult to stably form the amorphous phase 16. Therefore, CP is preferably 9.0 at. % or less, more preferably 7.0 at. % or less, still more preferably 5.0 at. % or less.

When CB is high, the amorphous phase 16 can be stably formed. In addition, as will be understood from examples described later, if CB is low when CSi is increased, Tx1/TL becomes small, and production becomes difficult. Therefore, CB is preferably 9.0 at. % or more, more preferably 9.5 at. % or more, still more preferably 10.0 at. % or more. In order to increase CB and to set CFe to 83.0 at. % or more, CP is lowered. If CP is too low, the coercive force will be high. Therefore, CB is preferably 12.0 at. % or less, more preferably 11.5 at. % or less, still more preferably 11.0 at. % or less.

When CP/CB increases, the size of the crystal phases 14 decreases, and the coercive force decreases. However, as CP increases, Tx2 decreases. Higher CSi results in larger Tx2. Therefore, CSi is preferably 1.1 at. % or more, more preferably 1.3 at. % or more, still more preferably 1.5 at. % or more. In order to increase CSi and to set CFe to 83.0 at. % or more, CP is lowered. If CP is too low, the coercive force will be high. Therefore, CSi is preferably 4.0 at. % or less, more preferably 3.5 at. % or less, still more preferably 3.0 at. % or less.

From the above viewpoints, in order to optimize the balance among Tx1/TL, Tx2, and the coercive force Hc, for example, CB-CSi is most preferably 6.5 at. % or more and 9.5 at. % or less.

It is preferable that C and impurities are not intentionally added. Therefore, CC is preferably 0 at. % or more and 2.0 at. % or less, more preferably 1.0 at. % or less, still more preferably 0.1 at. % or less. CI is preferably 0 at. % or more and 0.3 at % or less, more preferably 0.2 at. % or less, still more preferably 0.1 at. % or less. Each of the impurity elements is also preferably 0 at. % or more and 0.10 at. % or less, more preferably 0 at. % or more and 0.02 at. % or less.

### [Production Method]

Hereinafter, a method for producing a nanocrystalline alloy will be described. The method for producing the alloy according to the embodiments is not limited to the following method.

### [Method for Producing Amorphous Alloy]

A single roll method is used for producing the amorphous alloy. The conditions of the roll diameter and the rotation speed in the single roll method are arbitrary. The single roll method is suitable for producing an amorphous alloy because it is easy to rapidly cool. The cooling rate of the alloy molten for the production of the amorphous alloy is, for example, preferably 10⁴° C./sec or more, preferably 10⁶° C./sec or more. A method other than the single roll method including a period in which the cooling rate is 10⁴° C./sec may be used. For the production of the amorphous alloy, for example, a water atomization method or the atomization method described in Japanese Patent No. 6533352 may be used.

### [Method for Producing Nanocrystalline Alloy]

The nanocrystalline alloy is obtained by heat treatment of the amorphous alloy. In the production of the nanocrystalline alloy, the temperature history in the heat treatment affects the nanostructure of the nanocrystalline alloy. For example, in the heat treatment as shown in FIG. 1, the heating rate 45, the retention temperature T2, the length of the retention period 42, and the cooling rate 46 mainly affect the nanostructure of the nanocrystalline alloy.

### [Heating Rate]

When the heating rate 45 is high, a temperature range in which small Cu clusters are generated can be avoided, so that a large number of large Cu clusters are likely to be generated at the initial stage of crystallization. Therefore, the size of each crystal phase 14 decreases, the non-equilibrium reaction more easily proceeds, and the concentrations of P, B, Cu, and the like in the crystal phase 14 increase. Therefore, the total amount of the crystal phases 14 increases, and the saturation magnetic flux density increases. Further, P and Cu are concentrated in a region near the crystal phase 14, and as a result, the growth of the crystal phase 14 is suppressed, and the size of the crystal phase 14 is reduced. Therefore, the coercive force decreases. In the temperature range from 200° C. to the retention temperature T2, an average heating rate ΔT is preferably 360° C./min or more, more preferably 400° C./min or more. It is more preferable that the average heating rate calculated in increments of 10° C. in this temperature range satisfies the same condition. However, when it is necessary to release heat associated with crystallization as in the heat treatment after lamination, it is preferable to reduce the average heating rate. For example, such an average heating rate may be 5° C./min or less.

In order to lower the coercive force, the P concentration CP/the B concentration CB is preferably large. This is considered to be because small Cu clusters are more likely to be generated as the B concentration increases. Therefore, in order to offset the micronization of Cu clusters due to the increase in the B concentration, (CP/CB*(ΔT+20)) using CP/CB and ΔT is preferably 40° C./min or more, preferably 50° C./min or more, more preferably 100° C./min or more. It is still more preferable that (CP/CB*(ΔT+20)) calculated in increments of 10° C. in this temperature range satisfies the same condition.

### [Length of Retention Period]

The length of the retention period 42 is preferably a time in which it can be determined that crystallization has sufficiently progressed. In order to determine that the crystallization has sufficiently progressed, it is confirmed that a first peak corresponding to the first crystallization start temperature Tx1 cannot be observed or has become very small (for example, the calorific value was 1/100 or less of the total calorific value of the first peak in the DSC curve of the amorphous alloys having the same chemical composition) in a curve (DSC curve) obtained by heating the nanocrystalline alloy to about 650° C. at a constant heating rate of 40° C./min by differential scanning calorimetry (DSC).

When crystallization (crystallization at the first peak) approaches 100%, the rate of crystallization is very slow, and it may be impossible to determine by DSC whether crystallization has sufficiently progressed. Therefore, the length of the retention period is preferably longer than expected from the DSC result. For example, the length of the retention period is preferably 0.5 minutes or more, more preferably 5 minutes or more. The saturation magnetic flux density can be increased by sufficiently performing crystallization. If the retention period is too long, the concentration distribution of solute elements in the amorphous phase may change due to diffusion of atoms. Therefore, the length of the retention period is preferably 60 minutes or less, more preferably 30 minutes or less.

### [Retention Temperature]

The maximum temperature Tmax of the retention temperature T2 is preferably the first crystallization start temperature Tx1−20° C. or more and the second crystallization start temperature Tx2−20° C. or less. When Tmax is less than Tx1−20° C., crystallization does not sufficiently proceed. When Tmax exceeds Tx2−20° C., a compound crystal phase is formed, and the coercive force greatly increases. The recommended temperature of Tmax is Tx1+(CB/CP)*5° C. or more and Tx2−20° C. or less in order to offset the micronization of Cu clusters with an increase in the B concentration. Tmax is more preferably Tx1+(CB/CP)*5+20° C. or more. In addition, Tmax is preferably the Curie temperature of the amorphous phase 16 or more. By increasing Tmax, the temperature at which the spinodal decomposition starts increases, and λm increases. Therefore, it is possible to reduce the total number of Cu clusters at the initial stage of crystallization and to increase the number of large Cu clusters.

### [Cooling Rate]

When cooling is started, Cu that has formed a solid solution in the amorphous phase 16 is separated. Cu atoms and Fe atoms that have formed a solid solution in the amorphous phase 16 lower the magnetization of Fe by quantum mechanical action. As a result, the saturation magnetic flux density decreases. Therefore, in order to increase the saturation magnetic flux density, it is preferable that the cooling rate 46 is slow. On the other hand, if the cooling rate 46 is too slow, it takes time to produce the nanocrystalline alloy. From the above, the average cooling rate from when the temperature of the alloy reaches Tmax or Tx1+(CB/CP)*5 to 200° C. is preferably 0.2° C./sec or more and 0.5° C./sec or less. From the viewpoint of maintaining the structure obtained by the retention as much as possible and from the viewpoint of enhancing the production efficiency, the average cooling rate may be, for example, 100° C./min or more.

### [Amorphous Alloy]

The amorphous alloy as the precursor alloy of the nanocrystalline alloy in the first and second embodiments is composed only of the amorphous phase. Here, the phrase “composed only of the amorphous phase” means that a trace amount of a crystal phase may be contained as long as the effects of the first and second embodiments can be obtained.

An example of a method for determining whether the alloy is composed only of the amorphous phase will be described. Determination is performed using a diffraction pattern (for example, X-ray source: Cu-Kα ray; 1 step 0.02°; measurement time per step: 10 seconds) obtained with an X-ray diffractometer (such as Smartlab (registered trademark)-9 kW manufactured by Rigaku Corporation equipped with a counter monochromator: 45 kV, 200 mA). For a plate-shaped sample such as a ribbon and a thin strip, when a peak of iron having a BCC structure is not observed in the diffraction pattern obtained with the X-ray diffractometer at the center in the width direction of the sample and at a position separated from the surface of the sample by about ⅛ of the total thickness, it is determined that the amorphous alloy is composed only of the amorphous phase. In addition, for a sample such as a powder, the surface is pickled under an inert gas atmosphere until the mass decreases by about 0.1 mass % of the total mass of the weighed sample, and then when no peak of iron having the BCC structure is observed in the diffraction pattern obtained with the X-ray diffractometer of the dried sample, it is determined that the amorphous alloy is composed only of the amorphous phase.

In these cases, a peak in the diffraction pattern (peak in the vicinity of the (110) diffraction line of the BCC structure) is separated into the amorphous phase and the crystal phase (iron having the BCC structure) by waveform separation, and when the peak height of the crystal phase is 1/20 or less of the peak height of the amorphous phase, it is determined that the peak of iron having the BCC structure is not observed in the diffraction pattern obtained with the X-ray diffractometer. As the peak of iron having the BCC structure, both the (110) and (200) diffraction lines are observed. Even when a peak of iron having the BCC structure is not observed in the diffraction pattern, a trace amount of a crystal phase may be observed with a transmission electron microscope. However, it is difficult to quantify these trace amounts of crystal phases, and the influence on magnetic properties is also slight. Therefore, even when a trace amount of crystal phases is observed with a transmission electron microscope, it is considered that the amorphous alloy is composed only of the amorphous phase.

### [Nanocrystalline Alloy]

The nanocrystalline alloy 10 in the first and second embodiments, the amorphous phase 16, and the crystal phases 14 formed in the amorphous phase 16 are included. The proportion of the crystal phases 14 in the alloy 10 may be any proportion as long as the effects of the first and second embodiments can be obtained. For example, the alloy 10 includes crystal phases 14 to such an extent that a peak of iron having the BCC structure is observed in the diffraction pattern obtained with the X-ray diffractometer described above. For example, the alloy 10 may contain the crystal phases 14 in an amount of 10 area % or more and 70 area % or less when a position spaced apart by a distance of about ⅛ of the total thickness from the surface of a sample at the center in the width direction of the sample for a plate-shaped sample, or a position spaced apart by a distance of about ⅛ of the diameter from the surface of a sample close to the average grain size for a powdery sample, is observed with a transmission electron microscope at a magnification of 300,000 times. When the amount of the crystal phases 14 is large, the alloy tends to be brittle, so that the alloy tends to break during winding. Therefore, the amount of the crystal phases 14 can be appropriately adjusted according to the usage.

### EXAMPLES

Samples were prepared as follows.

### [Production of Amorphous Alloy]

As a starting material of the alloy, reagents such as iron (impurities of 0.01 wt % or less), boron (impurities of less than 0.5 wt %), triiron phosphide (impurities of less than 1 wt %), and copper (impurities of less than 0.01 wt %) were prepared. In the process of producing a nanocrystalline alloy from a mixture of these reagents, it was confirmed in advance that loss or mixing of elements did not occur. In this confirmation, among the chemical elements in the amorphous alloy and the nanocrystalline alloy, the B concentration was determined by absorptiometry, the C concentration was determined by infrared spectroscopy, and the P concentration and the Si concentration were determined by high-frequency inductively coupled plasma optical emission spectrometry. The Fe concentration was determined as the remainder by subtracting the total concentration of chemical elements other than Fe from 100%.

Prepared was 200 g of the mixture having a desired chemical composition. The mixture was heated in a crucible in an argon atmosphere to form a uniform molten metal. The molten metal was solidified in a copper mold to produce an ingot.

An amorphous alloy was produced from the ingot by a single roll method. In a quartz crucible, 30 grams of the ingot was molten and ejected from a nozzle having an opening of 10 mm×0.3 mm into a rotating roll made of pure copper. An amorphous ribbon having a width of 10 mm and a thickness of 20 μm was formed as an amorphous alloy on the rotating roll. The amorphous ribbon was stripped from the rotating roll by an argon gas jet. Using an X-ray diffractometer, it was confirmed by the above-described method that the amorphous ribbon was an amorphous alloy composed only of an amorphous phase.

Heat treatment was performed in an argon stream using an infrared gold image furnace to produce a nanocrystalline alloy ribbon from the amorphous alloy. As heat treatment conditions, the heating rate is 400° C./min, the retention temperature (heat treatment temperature) is Tx1+20° C., the length of the retention period is 1 minute, and the cooling rate is 0.2 to 0.5° C./sec. Tx1 and Tx2 were determined from DSC curves obtained by heating the amorphous alloy to about 650° C. at a constant heating rate of 40° C./min by DSC. In addition, TL was determined by differential thermal analysis (DTA) from the rising temperature of the first peak during cooling after the ingot was heated to 1350° C. at a constant heating rate of 10° C./min and then cooled at a constant heating rate of 10° C./min.

Table 1 shows chemical compositions (concentrations) in examples and comparative examples.

TABLE 1

| Sample | | CFe | CCu | CP | CB | CSi |
|---|---|---|---|---|---|---|
| No. | | [at. %] | [at. %] | [at. %] | [at. %] | [at. %] |
| 1 | Example 1 | 83.3 | 0.7 | 7.0 | 8.0 | 1.0 |
| 2 | Comparative | 83.3 | 0.7 | 6.0 | 8.0 | 2.0 |
| | Example 1 | | | | | |
| 3 | Comparative | 83.3 | 0.7 | 5.0 | 8.0 | 3.0 |
| | Example 2 | | | | | |
| 4 | Comparative | 83.3 | 0.7 | 4.0 | 8.0 | 4.0 |
| | Example 3 | | | | | |
| 5 | Comparative | 83.3 | 0.7 | 3.0 | 8.0 | 5.0 |
| | Example 4 | | | | | |
| 6 | Comparative | 83.3 | 0.7 | 2.0 | 8.0 | 6.0 |
| | Example 5 | | | | | |
| 7 | Comparative | 83.3 | 0.7 | 1.0 | 8.0 | 7.0 |
| | Example 6 | | | | | |
| 8 | Comparative | 83.3 | 0.7 | 6.0 | 10.0 | 0.0 |
| | Example 7 | | | | | |
| 9 | Example 2 | 83.3 | 0.7 | 5.0 | 10.0 | 1.0 |
| 10 | Example 3 | 83.3 | 0.7 | 4.0 | 10.0 | 2.0 |
| 11 | Example 4 | 83.3 | 0.7 | 3.0 | 10.0 | 3.0 |
| 12 | Comparative | 83.3 | 0.7 | 2.0 | 10.0 | 4.0 |
| | Example 8 | | | | | |
| 13 | Comparative | 83.3 | 0.7 | 1.0 | 10.0 | 5.0 |
| | Example 9 | | | | | |
| 14 | Comparative | 83.3 | 0.7 | 4.0 | 12.0 | 0.0 |
| | Example 10 | | | | | |

Table 2 shows Tx1, Tx2, the maximum temperature Tmax, Tx1/TL*100 (a value obtained by multiplying Tx1/TL by 100), a saturation magnetic flux density Bs, and the coercive force Hc in examples and comparative examples. The coercive force and the saturation magnetic flux density of the nanocrystalline alloy were measured using a direct current magnetization characteristic measuring apparatus model BHS-40 and a vibrating sample magnetometer PV-M10-5, respectively.

TABLE 2

| | | | | | Tx1/ | | |
|---|---|---|---|---|---|---|---|
| Sample | | Tx1 | Tx2 | Tmax | TL × 100 | Bs | Hc |
| No. | | [° C.] | [° C.] | [° C.] | [° C./° C.] | [T] | [A/m] |
| 1 | Example 1 | 411 | 516 | 431 | 40.0 | 1.69 | 3.8 |
| 2 | Comparative | 411 | 533 | 431 | 35.6 | 1.72 | 4.3 |
| | Example 1 | | | | | | |
| 3 | Comparative | 412 | 545 | 432 | 37.0 | 1.74 | 4.6 |
| | Example 2 | | | | | | |
| 4 | Comparative | 412 | 565 | 432 | 33.8 | 1.74 | 5.8 |
| | Example 3 | | | | | | |
| 5 | Comparative | 404 | 562 | 424 | 32.8 | 1.77 | 9.5 |
| | Example 4 | | | | | | |
| 6 | Comparative | 405 | 565 | 425 | 32.4 | 1.75 | 48.0 |
| | Example 5 | | | | | | |
| 7 | Comparative | 382 | 559 | 402 | 30.1 | 1.80 | 68.0 |
| | Example 6 | | | | | | |
| 8 | Comparative | 414 | 515 | 434 | 37.7 | 1.73 | 3.9 |
| | Example 7 | | | | | | |
| 9 | Example 2 | 415 | 535 | 435 | 36.8 | 1.74 | 4.9 |
| 10 | Example 3 | 418 | 541 | 438 | 42.8 | 1.73 | 5.0 |
| 11 | Example 4 | 416 | 554 | 436 | 38.4 | 1.72 | 7.7 |
| 12 | Comparative | 417 | 557 | 437 | 34.5 | 1.74 | 9.4 |
| | Example 8 | | | | | | |
| 13 | Comparative | 416 | 553 | 436 | 33.8 | 1.81 | 14.0 |
| | Example 9 | | | | | | |
| 14 | Comparative | 422 | 521 | 442 | 43.0 | 1.79 | 5.6 |
| | Example 10 | | | | | | |

The Fe concentration CFe is constant at 83.3 at. %, and the Cu concentration CCu is constant at 0.7 at. %. In samples Nos. 1 to 7, the B concentration CB is constant at 8.0 at. %, the total of the P concentration CP and the Si concentration CSi is 8.0 at. %, and CP and CSi are changed. In samples Nos. 8 to 13, the B concentration CB is constant at 10.0 at. %, the total of the P concentration CP and the Si concentration CSi is 6.0 at. %, and CP and CSi are changed. In the sample No. 8, CSi is set to 0.0 at. %. In a sample No. 14, the B concentration CB is at 12.0 at. %, the total of the P concentration CP and the Si concentration CSi is 4.0 at. %, and CP and CSi are respectively set at 4.0 at. % and 0.0 at. %.

The sample No. 1 corresponds to example 1, the samples Nos. 2 to 8 respectively correspond to comparative examples 1 to 7, the samples Nos. 9 to 11 respectively correspond to examples 2 to 4, and the samples Nos. 12 to 14 respectively correspond to comparative examples 8 to No. 10. Examples 1 and 2 correspond to examples of the first embodiment, and examples 3 and 4 correspond to examples of the second embodiment.

Referring to Tables 1 and 2, first, when comparing the sample No. 8 and the sample No. 14 having a CSi of 0.0 at. %, the sample No. 8 having a high CP has a coercive force Hc lower than that of the sample No. 14. When samples with the same CSi in the samples Nos. 1 to 5 and the samples Nos. 9 to 13 are compared, the coercive force Hc is lower in the samples Nos. 1 to 5 having higher CPs. This is considered to be because the size of the crystal phases is reduced by P.

However, as CP increases, Tx2 decreases. For example, in the sample Nos. 1, 8, and 14, Tx2 is about 520° C. When Tx2 is low, the difference between Tmax and Tx1 becomes small, it becomes difficult to control the temperature, it becomes easy to generate a compound crystal phase, and it becomes difficult to control the structure. Therefore, Tx2 can be increased by adding Si. If CSi becomes too high, Hc becomes high.

In order to make the coercive force Hc lower than 5.0 Nm, make Tx2 higher than 515° C., and make Tx1/TL*100 larger than 36, CP is preferably 5.0 at. % or more, more preferably 6.0 at. % or more. CSi is preferably 0.4 at. % or more, more preferably 0.5 at. % or more, still more preferably 0.7 at. % or more. CSi is preferably 1.9 at. % or less, more preferably 1.4 at. % or less, still more preferably 1.0 at. % or less.

In order to make the coercive force Hc lower than 8.0 Nm, make Tx2 higher than 540° C., and make Tx1/TL×100 larger than 38, CP is preferably 3.0 at. % or more, preferably 3.6 at. % or more. CSi is preferably 1.1 at. % or more, more preferably 1.5 at. % or more, still more preferably 2.0 at. % or more. CSi is preferably 4.0 at. % or less, more preferably 3.5 at. % or less.

Although the preferable examples of the invention have been described in detail above, the present invention is not limited to the specific examples, and various modifications and changes can be made within the scope of the gist of the present invention described in the claims.

### REFERENCE NUMERALS

10 Alloy
14 Crystal phase
16 Amorphous phase

1. An alloy comprising an amorphous phase, and including:
an average Fe concentration in an entire alloy of 82.0 at. % or more and 88.0 at. % or less;
an average Cu concentration in the entire alloy of 0.4 at. % or more and 1.0 at. % or less;
an average P concentration in the entire alloy of 5.0 at. % or more and 9.0 at. % or less;
an average B concentration in the entire alloy of 6.0 at. % or more and 10.0 at. % or less;
an average Si concentration in the entire alloy of 0.4 at. % or more and 1.9 at. % or less;
an average C concentration in the entire alloy of 0 at. % or more and 2.0 at. % or less;
an average impurity concentration of an impurity other than Fe, Cu, P, B, Si, and C in the entire alloy of 0 at. % or more and 0.3 at. % or less; and
a total of the average Fe concentration, the average Cu concentration, the average P concentration, the average B concentration, the average Si concentration, the average C concentration, and the average impurity concentration of 100.0 at. %.

2. The alloy according to claim 1,
wherein the average Fe concentration is 83.0 at. % or more and 88.0 at. % or less,
the average Cu concentration is 0.4 at. % or more and 0.9 at. % or less,
the average P concentration is 5.0 at. % or more and 8.0 at. % or less,
the average Si concentration is 0.9 at. % or more and 1.4 at. % or less,
the average C concentration is 0 at. % or more and 0.1 at. % or less, and
the average impurity concentration is 0 at. % or more and 0.1 at. % or less.

3. An alloy comprising an amorphous phase and including:
an average Fe concentration in an entire alloy of 82.0 at. % or more and 88.0 at. % or less;
an average Cu concentration in the entire alloy of 0.4 at. % or more and 0.9 at. % or less;
an average P concentration in the entire alloy of 3.0 at. % or more and 9.0 at. % or less;
an average B concentration in the entire alloy of 9.0 at. % or more and 12.0 at. % or less;
an average Si concentration in the entire alloy of 1.1 at. % or more and 4.0 at. % or less;
an average C concentration in the entire alloy of 0 at. % or more and 2.0 at. % or less;
an average impurity concentration of an impurity other than Fe, Cu, P, B, Si, and C in the entire alloy of 0 at. % or more and 0.3 at. % or less; and
a total of the average Fe concentration, the average Cu concentration, the average P concentration, the average B concentration, the average Si concentration, the average C concentration, and the average impurity concentration of 100.0 at. %.

4. The alloy according to claim 3,
wherein the average Fe concentration is 83.0 at. % or more and 88.0 at. % or less,
the average Cu concentration is 0.4 at. % or more and 0.8 at. % or less,
the average P concentration is 3.0 at. % or more and 5.0 at. % or less,
the average Si concentration is 1.5 at. % or more and 4.0 at. % or less,
the average C concentration is 0 at. % or more and 0.1 at. % or less, and
the average impurity concentration is 0 at. % or more and 0.1 at. % or less.

5. The alloy according to claim 1, comprising the amorphous phase and a plurality of crystal phases formed in the amorphous phase.

6. The alloy according to claim 1, composed only of the amorphous phase.
